(19) United States
(12) Patent Application Publication
(10) Pub. No.: US 2026/0030172 A1
(43) Pub. Date: Jan. 29, 2026

(54) ADDRESS CONVERSION TABLE SUPPORTING HARDWARE AUTOMATION

(71) Applicant: Micron Technology, Inc., Boise, ID (US)

(72) Inventors: Wenjun Wu, Shanghai (CN); Deping He, Boise, ID (US); Xing Wang, Shanghai (CN); Qingyuan Wang, Shanghai (CN); Xiaolai Zhu, Shanghai (CN)

(21) Appl. No.: 19/276,501

(22) Filed: Jul. 22, 2025

Related U.S. Application Data
(60) Provisional application No. 63/674,913, filed on Jul. 24, 2024.

(51) Int. Cl. G06F 12/1009

(52) U.S. Cl. CPC G06F 12/1009; G06F 2212/1024

(57) ABSTRACT

Methods, systems, and devices for address conversion table supporting hardware automation are described. A memory system may implement a hardware logic block to perform the conversion of a logical page address to a physical device address. The hardware logic block may include a set of one or more tables for address conversion, including a page mapping table, a page type change point table, and a virtual block table, which may support performing the conversion of the logical page address to a physical device address using hardware logic. To account for varying parameters of the memory system, the firmware may load one or more parameters for the hardware logic block, for example, during initialization of the memory system. As such, the hardware logic block may support converting logical page addresses to physical device addresses for various different memory systems and memory system configurations.

### CROSS REFERENCE

The present Application for Patent claims priority to U.S. Patent Application No. 63/674,913 by Wu et al., entitled “ADDRESS CONVERSION TABLE SUPPORTING HARDWARE AUTOMATION,” filed Jul. 24, 2024, which is assigned to the assignee hereof, and which is expressly incorporated by reference in its entirety herein.

### TECHNICAL FIELD

The following relates to one or more systems for memory, including address conversion table supporting hardware automation.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports implementing tables for performing address conversion in hardware in accordance with examples as disclosed herein.

FIG. 2 shows an example of a system that supports implementing tables for performing address conversion in hardware in accordance with examples as disclosed herein.

FIG. 3 shows an example of a mapping circuit that supports implementing tables for performing address conversion in hardware in accordance with examples as disclosed herein.

FIG. 4 shows a block diagram of a memory system that supports implementing tables for performing address conversion in hardware in accordance with examples as disclosed herein.

FIGS. 5 and 6 show flowcharts illustrating a method or methods that support implementing tables for address conversion in hardware in accordance with examples as disclosed herein.

### DETAILED DESCRIPTION

In some systems, logical to physical device address mapping may be performed as a two-step process, where the logical address is first converted to a logical page address, and then the logical page address is converted to a physical device address (e.g., an address corresponding to a memory die, a plane, or other physical location parameters). The first step may be performed by a controller (e.g., a memory controller) loading a portion of a logical-to-physical (L2P) table to a location (e.g., a memory buffer) accessible by a hardware logic block, and the hardware logic block may then perform the L2P mapping from the logical address to the logical page address. The controller may then perform additional instructions in firmware to convert the logical page address to a physical device address based on various parameters associated with configuration of the physical memory devices of the memory system (e.g., quantity of memory dies, quantity of planes of each memory die, mapping type information). As such, the controller may convert the logical page address to the physical device address while accounting for different configurations of the memory system, which may vary. However, performing the conversion of the logical page address to the physical device address in firmware may introduce additional latency to the memory system.

In accordance with examples as described herein, a memory system may implement an additional hardware logic block to perform the conversion of the logical page address to the physical device address. The hardware logic block may include a set of one or more tables for address conversion, including a page mapping table, a page type change point table, and a virtual block table, which may support performing the conversion of the logical page address to a physical device address using hardware logic. As such, the conversion may be performed using hardware logic, which may reduce latency and improve throughput, while reducing power consumption. To account for varying parameters of the memory system, the firmware may load one or more parameters for the hardware logic block, for example, during initialization of the memory system. As such, the hardware logic block may support converting logical page addresses to physical device addresses for various different memory systems and memory system configurations.

In addition to applicability in memory systems as described herein, techniques for implementing address conversion tables using hardware logic may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing latency and improving response times, which may support increased read performance and throughput for various applications, including AI, AR, VR, and gaming, among other benefits.

Features of the disclosure are illustrated and described in the context of systems, devices, and circuits. Features of the disclosure are further illustrated and described in the context of mapping circuits, block diagrams, and flowcharts.

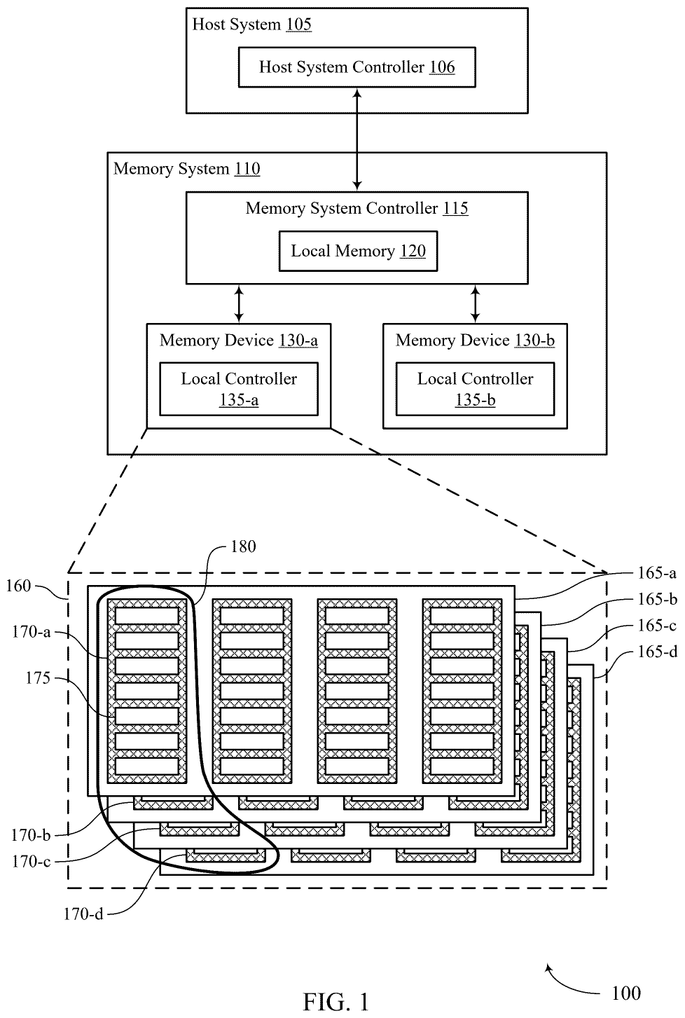

FIG. 1 shows an example of a system 100 that supports implementing tables for performing address conversion in hardware in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). The addressing for the memory system 110 over the physical host interface may be according to a logical address space that may include a range of address (e.g., continuous range of addresses). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., separate, hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to accessing within a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells or synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, a used page 175 may, in some cases, not be updated until the entire block 170 that includes the page 175 has been erased.

In some cases, L2P mapping tables may be maintained to track corresponding logical page addresses for data, and the data may be marked as valid or invalid at the page level of granularity (e.g., a page 175 may contain valid data, invalid data, or no data). Invalid data may be data that is outdated, which may be due to a more recent or updated version of the data (e.g., for a given logical address) being stored in a different physical location of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some systems, logical to physical device address mapping may be performed as a two-step process, where a logical address received from the host system 105 is first converted to logical page address, which may be an address space (e.g., continuous address space) that has a one-to-one correspondence with a physical device address. Then, the logical page address is converted to a physical device address, which may correspond to a memory device 130, a plane 165, a block 170, a page 175, or a combination of these physical location identifiers. In some cases, the conversion of the logical address to the logical page address may be performed by the memory system controller 115 (e.g., or another controller of the memory system 110) by loading a portion of an L2P table to a location (e.g., a memory buffer) accessible by a hardware logic block. The hardware logic block may then perform the L2P mapping from the logical address to the logical page address. The memory system controller 115 may then perform additional instructions in firmware to convert the logical page address to a physical device address based on various parameters associated with configuration of the memory die of the memory system 110 (e.g., quantity of memory devices 130, quantity of planes 165 of each memory device 130, mapping type information). As such, the memory system controller 115 may convert the logical page address to the physical device address while accounting for different configurations of the memory system, which may vary. However, performing the conversion of the logical page address to the physical device address in firmware may introduce additional latency to the memory system 110.

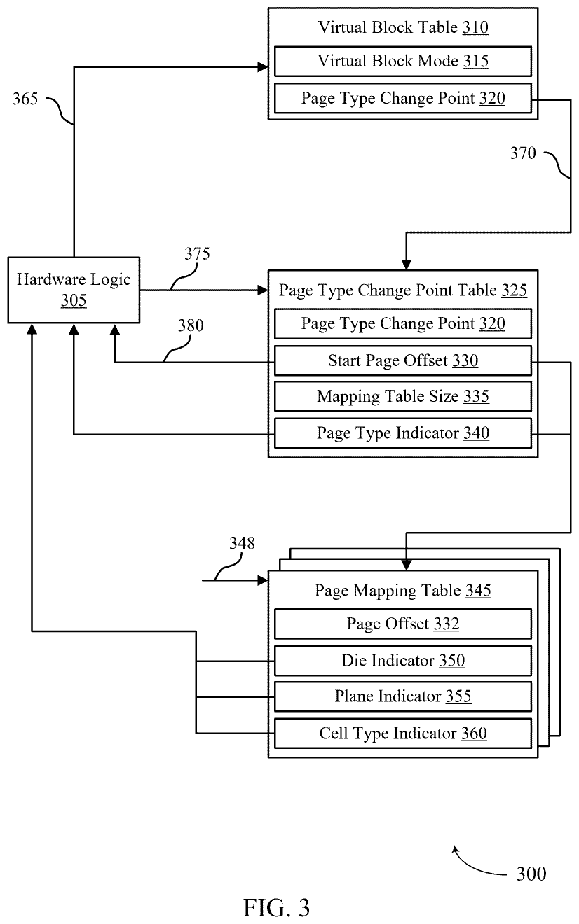

In accordance with examples as described herein, the memory system 110 may implement an additional hardware logic block to perform the conversion of the logical page address to the physical device address. The hardware logic block may use a set of one or more tables for address conversion, including a page mapping table and a page type table, which may support performing the conversion of the logical page address to a physical device address using hardware logic. These tables are described in more detail herein, with reference to FIG. 3. As such, the conversion may be performed using hardware logic, which may reduce latency and improve throughput, while reducing power consumption. To account for varying parameters of the memory system 110, the memory system controller 115 may load one or more parameters for the hardware logic block, for example, during initialization of the memory system 110. As such, the hardware logic block may support converting logical page addresses to physical device addresses for various different memory systems and memory system configurations.

The system 100 may include any quantity of non-transitory computer readable media that support implementing tables for address conversion in hardware. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

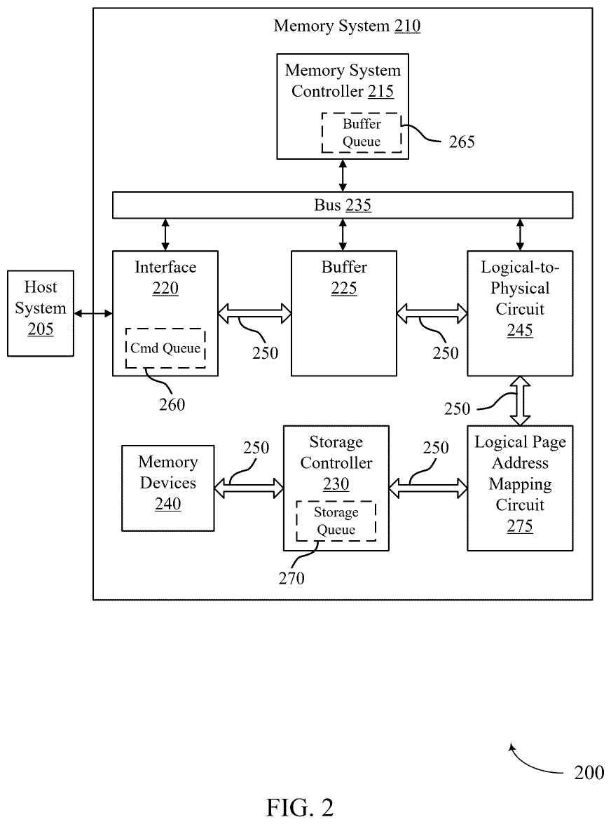

FIG. 2 shows an example of a system 200 that supports implementing tables for performing address conversion in hardware in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address such as a physical device address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). The interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical device addresses) associated with memory cells within the memory devices 240. For example, the host system 205 may issue commands indicating one or more LBAs and the memory system controller 215 may identify one or more physical device addresses associated with the LBAs. In some cases, one or more contiguous LBAs may correspond to noncontiguous physical device addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted. Additionally, or alternatively, one or more storage controllers 230 may perform functions that are described with reference to the memory system controller 215.

In some cases, the memory system controller 215 may be or include an ASIC. The ASIC may be designed to support various designs for different memory systems 210. For example, the ASIC may be designed to support memory systems 210 that have yet to be released. However, various parameters may vary between memory systems 210, especially as new memory systems 210 are created. For example, the layout of data stored at the memory systems 210 may vary, which may be based on quantity of memory die, memory cell types, quantities of memory pages, blocks, or planes, dynamic ECC, dynamic XOR, or other functions or parameters used by the memory system 210. To support flexible data layouts, the memory system 210 may perform logical to physical device address mapping as a two-step process.

For example, a logical address (e.g., LBA) received from the host system 205 may be converted into a logical page address using a logical-to-physical circuit 245. In some examples, the memory system controller 215 may load a portion of an L2P table into the buffer 225, and the logical-to-physical circuit 245 may use the portion of the L2P table to obtain a corresponding logical page address. To retain the flexibility of data layouts, the memory system 210 may then convert the logical page address into a physical device address using firmware (e.g., software). For example, the firmware may be loaded or updated based on parameters of the specific memory system 210 (e.g., data layout parameters, quantity of memory devices 240, quantity of planes of each memory device, or other mapping information). In some cases, performing the conversion of the logical page address into a physical device address using firmware may limit read performance of the memory system 210. For example, to support higher read throughput, the memory system 210 may increase clock frequencies and power consumption, which may be unsustainable for supporting high throughput for extended periods of time.

In accordance with examples as described herein, the memory system 210 may support performing conversion of logical page addresses into physical device addresses using hardware logic. For example, the memory system may include a logical page address mapping circuit 275. In some examples, the logical page address mapping circuit 275 may receive an indication of a logical page address from the logical-to-physical circuit 245. The logical page address mapping circuit 275 may then convert the logical page address to a physical device address, which may be output to the storage controller 230 (e.g., or another component of the memory system 210, such as the memory system controller 215) for use in accessing the memory devices 240.

In some examples, the logical page address mapping circuit 275 may use one or more tables to perform the conversion of the logical page address to the physical device address. For example, the memory system controller 215 may obtain initialization information (e.g., during an initialization of the memory system 210), for example, based on detecting a power on condition of for the memory system 210. The initialization information may include one or more parameters for the logical page address mapping circuit 275 to load the one or more tables. For example, the initialization information may include information relating to (e.g., mappings between) virtual block modes and page type change points for a virtual block table, page offsets, mapping table sizes, and page type indicators relating to the page type change points for a page type change point table, and page offsets, die indicators, plane indicators, and cell type indicators for a page mapping table, as described herein with reference to FIG. 3. As such, the initialization information may be based on the specific data layout used by the memory system 210, including the page types, cell types, page sizes, quantity of planes, quantity of memory devices, and other parameters corresponding to the memory system 210. In some examples, the initialization information may include information corresponding to one or more page type change point tables, one or more virtual block tables, and one or more page mapping tables. These tables are described in more detail herein, with reference to FIG. 3.

In some examples, the memory system controller 215 may obtain the initialization information from an instruction set loaded to the firmware of the memory system controller 215. The memory system controller 215 may load the parameters corresponding to the one or more tables into one or more registers (e.g., mode registers), which may output the parameters to the logical page address mapping circuit 275 for performing conversion of logical page addresses. Accordingly, the logical page address mapping circuit 275 may support hardware conversion of the logical page address while still supporting the flexibility of data layouts, thereby improving performance and throughput of the memory system 210 while processing access operations.

FIG. 3 shows an example of a mapping circuit 300 that supports implementing tables for performing address conversion in hardware in accordance with examples as disclosed herein. The mapping circuit 300 illustrates the use of hardware logic 305 as part of a hardware block of a memory system. For example, the page address mapping circuit 300 may be an example of the logical page address mapping circuit 275, as described with reference to FIG. 2, and may be implemented within a memory system as described herein.

The mapping circuit 300 may use a set of tables to perform conversion of logical page addresses to physical addresses. For example, the mapping circuit 300 may include a virtual block table 310, a page type change point table 325, and a page mapping table 345. In some examples, these tables may be defined based on one or more parameters stored by the memory system (e.g., at one or more registers), which may be loaded during initialization of the memory system as described with reference to FIG. 2. For example, the tables may be implemented as a set of one or more hardware blocks (e.g., ASIC blocks) that have (e.g., or access) parameters (e.g., from the one or more registers), and each hardware block may output one or more corresponding parameters based on inputs received from other hardware blocks.

The hardware logic 305 may obtain an indication of a logical page address 375 to be converted (e.g., from a logical-to-physical circuit 245). For example, the hardware logic 305 may receive the logical page address 375 based on a logical to physical table logic (e.g., logical-to-physical circuit 245), which may calculate the logical page address 375 based on a logical address (e.g., provided by a host device) and at least a portion of an L2P table. The hardware logic 305 may also receive an indication of a virtual block 365 corresponding to the logical page address, and the virtual block table 310 may determine a virtual block mode 315 based on the virtual block 365. Additionally, or alternatively, the virtual block table 310 may receive an indication of the virtual block mode 315 (e.g., from a controller of the memory system).

To convert the logical page address 375 into a physical device address, the virtual block table 310 may receive or determine the virtual block mode 315. The virtual block table 310 may store a set of usage modes for memory cells of the memory system (e.g., whether the memory cells are operated as SLCs, TLCs, QLCs, or other operating techniques). Additionally, or alternatively, the virtual block table 310 may store page type change points 320, which may define which regions of memory cells (e.g., of pages) are operated using each usage mode, and the change point (e.g., page) at which memory cells begin being operated using each usage mode. In some examples, the virtual block mode 315 may be used as the index for the virtual block table 310. For example, each virtual block mode 315 may correspond to a respective page type change point 320 in accordance with the virtual block table 310. As such, the virtual block table 310 may output an indication 370 of a page type change point 320 corresponding to the virtual block mode 315. For example, the virtual block table 310 may input the page type change point 320 to the page type change point table 325. Additionally, at 375, the hardware logic 305 may output the logical page address 375 to the page type change point table 325.

The page type change point table 325 may be used to select a page mapping table 345 of a set of page mapping tables 345 based on the page type change point 320 and the logical page address 375. In some examples, the page type change point 320 may be used as the index for the page type change point table 325. For example, each page type change point 320 may correspond to a respective start page offset 330 (e.g., an offset from the start of the page, starting page offset), a mapping table size 335, and a page type indicator 340.

At 380, the page type change point table 325 may output a physical page address 380 corresponding to the logical page address based on the page offset 330 obtained using the logical page address and the page type change point 320 to the hardware logic 305, which may be used to determine a physical page within a memory device during an access operation, for example. Additionally, or alternatively, the hardware logic 305 may provide the physical page address to one or more controllers (e.g., a storage controller, a local memory controller, or another controller) to perform the access operation at the page indicated by the physical page address. In some examples, the physical page address may be calculated (e.g., by the page type change point table 325) according to Equation 1 below.

$$Physical Page Address = Start Page Offset + \frac{( LPA - Page Type Change Point )}{Mapping Table Size} \qquad ( 1 )$$

where StartPageOffset corresponds to the start page offset 330 indicated based on the page type change point 320.

In some examples, the page type change point table 325 may output the page type indicator 340 corresponding to the page type change point 320 obtained from the virtual block table 310. For example, the page type change point 320 may be used to identify a page type indicator 340 (e.g., a page type number), which may be selected from a set of page type indicators 340. For example, each page type indicator 340 may be one of an SLC type, an MLC type, a TLC type, a TLC with weak-word-line type, a QLC type, or a combination thereof, which may indicate whether memory cells of the corresponding page are operated as SLCs, MLCs, TLCs, TLCs having a weak word line, QLCs, or a combination thereof, respectively. By outputting the page type indicator 340 to the hardware logic 305, the hardware logic may provide an indication of the page type to a controller (e.g., a storage controller, a local memory controller, a memory system controller), which may be used by the controller to access the cell using the corresponding operating techniques.

In some examples, the page type indicator 340 may be used to select a page mapping table 345 from a set of page mapping tables 345. For example, the mapping circuit 300 may implement a page mapping table 345 for each page type indicator 340 (e.g., corresponding to SLCs, MLCs, TLCs, TLCs with weak word line, and QLCs). In some examples, the page type change point 320 may indicate a page offset 332, which may be calculated based on the logical page address, the page type page point 320, and the mapping table size 335. For example, the page offset 332 may be calculated according to Equation 2below based on the inputs from the virtual block table 310 and the hardware logic 305.

$$Page Offset = ( LPA - Page Type Change Point ) \% Mapping Table Size \qquad ( 2 )$$

where LPA refers to the logical page address received at 375. The page type change point table 325 may input the page offset 332 into the selected page mapping table 345. The page offset 332 may correspond to the index of the page mapping table 345, and may be used to identify a die indicator 350, a plane indicator 355, and a cell type indicator 360 corresponding to the page offset 330.

The page mapping table 345 selected based on the page type indicator 340 may output the die indicator 350, the plane indicator 355, and the cell type indicator 360 to the hardware logic 305. The die indicator 350 may indicate a memory die (e.g., a memory device) of the memory system corresponding to the logical page address. Additionally, the plane indicator 355 may indicate a plane of the memory die corresponding to the logical page address. In some examples, a set of page mapping tables 345 may be configured (e.g., by a host system, by one or more controllers of the memory system) with a corresponding set of information 348 during an initialization procedure for the memory system, as described with reference to FIG. 2. For example, the page mapping table 345 may be selected from a set of page mapping tables based on an indicator of a quantity of memory die, a quantity of planes per memory die, a quantity of blocks per memory plane. As such, the page mapping tables 345 may flexibly accommodate various types of data layouts for the memory system.

In some examples, the cell type indicator 360 may correspond to a cell type corresponding to the logical page address, which may be one of a lower page (e.g., LP) type, an upper page (e.g., UP) type, or an extra page (e.g., XP) type. In some cases, each cell type may correspond to a set of read voltages to be applied to read the page from a set of memory cells. As such, the hardware logic 305 may obtain the corresponding physical device address within a page identified by the physical page address based on the die indicator 350, the plane indicator 355. Additionally, the hardware logic 305 may use the page type indicator 340 and the cell type indicator 360 to accessing the physical device address (e.g., by determining read voltage, a type of access operation, and other parameters for an access operation).

Accordingly, the mapping circuit 300 may be used to obtain a set of indicators for a physical device address corresponding to a logical page address, which may include the die indicator 350, the plane indicator 355, the physical page address 380, the page type indicator 340 and the cell type indicator 360. The set of indicators may be input by the hardware logic 305 into one or more controllers to perform access operations. The mapping circuit 300 may be hardware logic circuits (e.g., logic gates, registers, combinatorial logic) and not rely on executable code running in a processor (e.g., software, firmware) which may have indeterminate timing or latency, while supporting different memory system storage layouts and access techniques (e.g., SLC, TLC, QLC) by varying the parameters defining the tables during initialization.

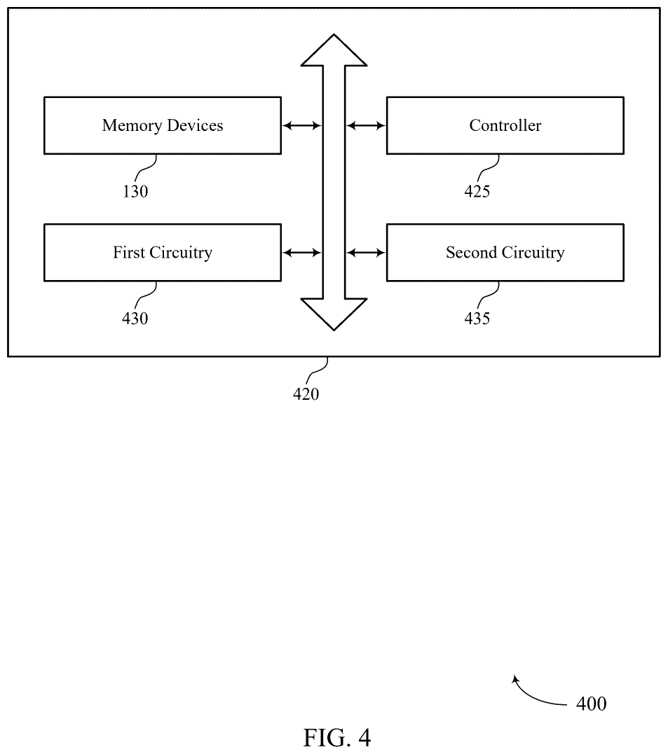

FIG. 4 shows a block diagram 400 of a memory system 420 that supports implementing tables for performing address conversion in hardware in accordance with examples as disclosed herein. The memory system 420 may be an example of aspects of a memory system as described with reference to FIGS. 1 through 3. The memory system 420, or various components thereof, may be an example of means for performing various aspects of address conversion table supporting hardware automation as described herein. For example, the memory system 420 may include a controller 425, a first circuitry 430, a second circuitry 435, or any combination thereof.

The controller 425 may be an example of any one or more controllers of a memory system as described herein operating individually or collectively, such as a local controller 135, a memory system controller 215, or a storage controller 230 as described with reference to FIGS. 1 and 2. The first circuitry 430 may refer to one or more hardware blocks for obtaining a logical page address from a logical address, and may be an example of the logical-to-physical circuit. The second circuitry 435 may refer to one or more hardware blocks for obtaining a physical address (e.g., a physical page address) from the logical page address, as described with reference to the mapping circuit 300 in FIG. 3. Each of these components, or components of subcomponents thereof (e.g., one or more processors, one or more memories), may communicate, directly or indirectly, with one another (e.g., via one or more buses).

The controller 425 may be configured as or otherwise support a means for a identifying, via one or more controllers coupled with one or more memory devices, a logical address associated with an access operation for the memory system and to load at least a portion of an address mapping table, the address mapping table correlating logical addresses to logical page addresses of a logical page address space, where the one or more memory devices are each configured according to one or more regions of one or more of a plurality of page types. The first circuitry 430 may be configured as or otherwise support a means for obtaining the at least the portion of the address mapping table and the logical address. In some examples, the first circuitry 430 may be configured as or otherwise support a means for outputting a first logical page address in accordance with the at least the portion of the address mapping table and the logical address. The second circuitry 435 may be configured as or otherwise support a means for obtaining the first logical page address, a quantity of the one or more memory devices, and one or more page type change point tables associated with the one or more regions of the one or more of the plurality of page types. In some examples, the second circuitry 435 may be configured as or otherwise support a means for outputting a set of indicators of a physical memory location of the one or more memory devices, where the set of indicators includes an indicator of a physical page address, an indicator of a memory device of the one or more memory devices, an indicator of a page type of the plurality of page types associated with the physical memory location, and an indicator of a page for the access operation.

In some examples, the second circuitry 435 may be configured as or otherwise support a means for determinizing, via the second circuitry, a page offset in accordance with the first logical page address, a page type change point, and a size of a page mapping table. In some examples, the second circuitry 435 may be configured as or otherwise support a means for inputting the page offset into the page mapping table to determine the memory device, where outputting the indicator of the physical page address is in accordance with the page offset being input into the page mapping table.

In some examples, the second circuitry 435 may be configured as or otherwise support a means for determining the page type change point from a virtual block table in accordance with a virtual block associated with the first logical page address, where the page type change point is associated with a page type change point table of the one or more page type change point tables.

In some examples, the second circuitry 435 may be configured as or otherwise support a means for determining the size of the page mapping table in accordance with a page type change point table associated with the page type change point.

In some examples, to support an address conversion table for hardware automation, the second circuitry 435 may be configured as or otherwise support a means for outputting the set of indicators of the physical memory location of the one or more memory devices in accordance with a quantity of the one or more memory planes, the set of indicators including an indicator of a plane of the one or more memory planes.

In some examples, the physical page address further includes an indication of cell type. In some examples, the cell type corresponds to a lower page, an upper page, or an extra page. In some examples, the page type corresponds to a single-level cell type, a multi-level cell type, a triple-level cell type, or a quad-level cell type.

In some examples, the controller 425 may be configured as or otherwise support a means for obtaining, via one or more controllers coupled with one or more memory devices, initialization information in response to detection of a power on condition for the memory system, where the initialization information includes one or more parameters for a page mapping table, where each of the one or more memory devices include one or more memory planes and configured according to one or more regions of one or more of a plurality of page types. In some examples, the controller 425 may be configured as or otherwise support a means for outputting, via the one or more controllers, the one or more parameters to second circuitry. In some examples, the controller 425 may be configured as or otherwise support a means for identifying, via the one or more controllers, a logical address associated with an access operation for the memory system and to load at least a portion of an address mapping table, the address mapping table correlating logical addresses to logical page addresses of a logical page address space. In some examples, the first circuitry 430 may be configured as or otherwise support a means for obtaining, via first circuitry, the at least the portion of the address mapping table and the logical address and to output a first logical page address in accordance with the at least the portion of the address mapping table and the logical address. In some examples, the second circuitry 435 may be configured as or otherwise support a means for outputting, via the second circuitry, a set of indicators of a physical memory location of the one or more memory devices in accordance with the first logical page address and the one or more parameters.

In some examples, the set of indicators includes an indicator of a physical page address, an indicator of a memory device of the one or more memory devices, an indicator of a plane of the one or more memory planes, an indicator of a page type of the plurality of page types associated with the physical memory location, and an indicator of a page for the access operation.

In some examples, the initialization information includes a plurality of page type change point tables, each of the plurality of page type change point tables being associated with a respective page type change point and a respective size of a respective page mapping table.

In some examples, the second circuitry 435 may be configured as or otherwise support a means for determining, via the second circuitry, a page offset in accordance with the first logical page address, a page type change point of the respective page type change points, and a size of a page mapping table of the respective page mapping tables. In some examples, the second circuitry 435 may be configured as or otherwise support a means for inputting, via the second circuitry, the page offset into the page mapping table to determine the memory device and the plane, where outputting the set of indicators of the physical memory location is in response to the page offset being input into the page mapping table.

In some examples, to support an address conversion table for hardware automation, the second circuitry 435 may be configured as or otherwise support a means for determining, via the second circuitry, the page type change point from the virtual block table in accordance with a virtual block associated with the first logical page address.

In some examples, each of the plurality of page type change point tables is associated with a respective page type. In some examples, each respective page type corresponds to one of a single-level cell type, a multi-level cell type, a triple-level cell type, or a quad-level cell type. In some examples, each respective cell type corresponds to one of a lower page, an upper page, or an extra page.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

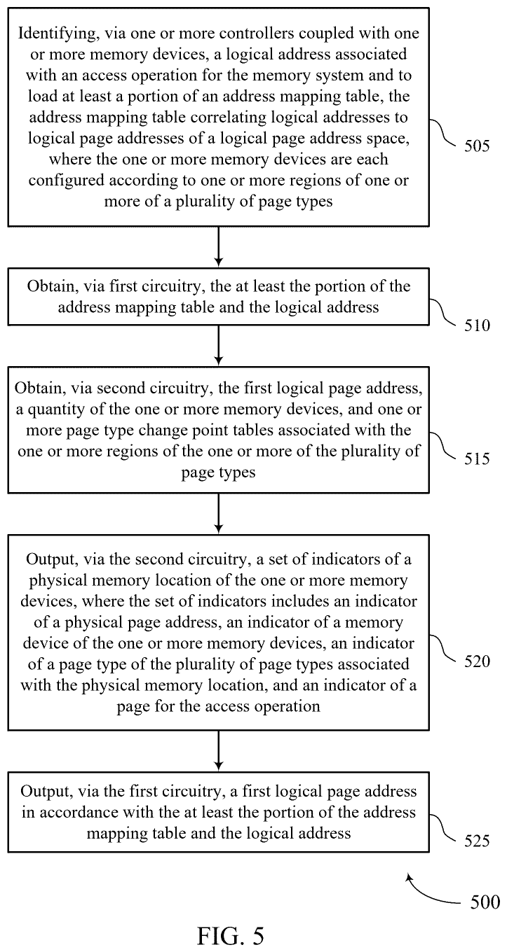

FIG. 5 shows a flowchart illustrating a method 500 that supports implementing tables for performing address conversion in hardware in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include identifying, via one or more controllers coupled with one or more memory devices, a logical address associated with an access operation for the memory system and to load at least a portion of an address mapping table, the address mapping table correlating logical addresses to logical page addresses of a logical page address space, where the one or more memory devices are each configured according to one or more regions of one or more of a plurality of page types. In some examples, aspects of the operations of 505 may be performed by a controller 425 as described with reference to FIG. 4.

At 510, the method may include obtaining the at least the portion of the address

mapping table and the logical address. In some examples, aspects of the operations of 510 may be performed by a first circuitry 430 as described with reference to FIG. 4.

At 515, the method may include obtaining the first logical page address, a quantity of the one or more memory devices, and one or more page type change point tables associated with the one or more regions of the one or more of the plurality of page types. In some examples, aspects of the operations of 515 may be performed by a second circuitry 435 as described with reference to FIG. 4.

At 520, the method may include outputting a set of indicators of a physical memory location of the one or more memory devices, where the set of indicators includes an indicator of a physical page address, an indicator of a memory device of the one or more memory devices, an indicator of a page type of the plurality of page types associated with the physical memory location, and an indicator of a page for the access operation. In some examples, aspects of the operations of 520 may be performed by a second circuitry 435 as described with reference to FIG. 4.

At 525, the method may include outputting, via the first circuitry, a first logical page address in accordance with the at least the portion of the address mapping table and the logical address. In some examples, aspects of the operations of 525 may be performed by a first circuitry 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for identifying, via one or more controllers coupled with one or more memory devices, a logical address associated with an access operation for the memory system and to load at least a portion of an address mapping table, the address mapping table correlating logical addresses to logical page addresses of a logical page address space, where the one or more memory devices are each configured according to one or more regions of one or more of a plurality of page types; obtaining, via first circuitry, the at least the portion of the address mapping table and the logical address; outputting, via the first circuitry, a first logical page address in accordance with the at least the portion of the address mapping table and the logical address; obtaining, via second circuitry, the first logical page address, a quantity of the one or more memory devices, and one or more page type change point tables associated with the one or more regions of the one or more of the plurality of page types; and outputting, via the second circuitry, a set of indicators of a physical memory location of the one or more memory devices, where the set of indicators includes an indicator of a physical page address, an indicator of a memory device of the one or more memory devices, an indicator of a page type of the plurality of page types associated with the physical memory location, and an indicator of a page for the access operation.

Aspect 2: The method, apparatus, or non-transitory computer-readable medium of aspect 1, further including operations, features, circuitry, logic, means, or instructions, or any combination thereof for determinizing, via the second circuitry, a page offset in accordance with the first logical page address, a page type change point, and a size of a page mapping table and inputting, via the second circuitry, the page offset into the page mapping table to determine the memory device, where outputting the indicator of the physical page address is in accordance with the page offset being input into the page mapping table.

Aspect 3: The method, apparatus, or non-transitory computer-readable medium of aspect 2, further including operations, features, circuitry, logic, means, or instructions, or any combination thereof for determining, via the second circuitry, the page type change point from a virtual block table in accordance with a virtual block associated with the first logical page address, where the page type change point is associated with a page type change point table of the one or more page type change point tables.

Aspect 4: The method, apparatus, or non-transitory computer-readable medium of aspect 3, further including operations, features, circuitry, logic, means, or instructions, or any combination thereof for determining, via the second circuitry, the size of the page mapping table in accordance with a page type change point table associated with the page type change point.

Aspect 5: The method, apparatus, or non-transitory computer-readable medium of any of aspects 1 through 4, where and the method, apparatuses, and non-transitory computer-readable medium includes operations, features, circuitry, logic, means, or instructions, or any combination thereof for outputting, via the second circuitry, the set of indicators of the physical memory location of the one or more memory devices in accordance with a quantity of the one or more memory planes, the set of indicators including an indicator of a plane of the one or more memory planes.

Aspect 6: The method, apparatus, or non-transitory computer-readable medium of any of aspects 1 through 5, where the physical page address further includes an indication of cell type.

Aspect 7: The method, apparatus, or non-transitory computer-readable medium of aspect 6, where the cell type corresponds to a lower page, an upper page, or an extra page.

Aspect 8: The method, apparatus, or non-transitory computer-readable medium of any of aspects 1 through 7, where the page type corresponds to a single-level cell type, a multi-level cell type, a triple-level cell type, or a quad-level cell type.

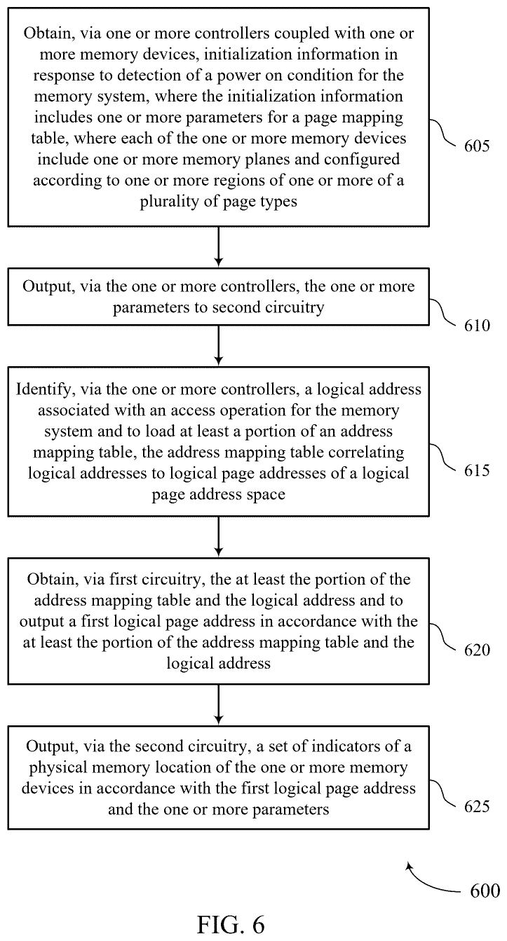

FIG. 6 shows a flowchart illustrating a method 600 that supports implementing tables for performing address conversion in hardware in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include obtaining, via one or more controllers coupled with one or more memory devices, initialization information in response to detection of a power on condition for the memory system, where the initialization information includes one or more parameters for a page mapping table, where each of the one or more memory devices include one or more memory planes and configured according to one or more regions of one or more of a plurality of page types. In some examples, aspects of the operations of 605 may be performed by a controller 425 as described with reference to FIG. 4.

At 610, the method may include outputting, via the one or more controllers, the one or more parameters to second circuitry. In some examples, aspects of the operations of 610 may be performed by a controller 425 as described with reference to FIG. 4.

At 615, the method may include identifying, via the one or more controllers, a logical address associated with an access operation for the memory system and to load at least a portion of an address mapping table, the address mapping table correlating logical addresses to logical page addresses of a logical page address space. In some examples, aspects of the operations of 615 may be performed by a controller 425 as described with reference to FIG. 4.

At 620, the method may include obtaining, via first circuitry, the at least the portion of the address mapping table and the logical address and to output a first logical page address in accordance with the at least the portion of the address mapping table and the logical address. In some examples, aspects of the operations of 620 may be performed by a first circuitry 430 as described with reference to FIG. 4.

At 625, the method may include outputting a set of indicators of a physical memory location of the one or more memory devices in accordance with the first logical page address and the one or more parameters. In some examples, aspects of the operations of 625 may be performed by a second circuitry 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for obtaining, via one or more controllers coupled with one or more memory devices, initialization information in response to detection of a power on condition for the memory system, where the initialization information includes one or more parameters for a page mapping table, where each of the one or more memory devices include one or more memory planes and configured according to one or more regions of one or more of a plurality of page types; outputting, via the one or more controllers, the one or more parameters to second circuitry; identifying, via the one or more controllers, a logical address associated with an access operation for the memory system and to load at least a portion of an address mapping table, the address mapping table correlating logical addresses to logical page addresses of a logical page address space; obtaining, via first circuitry, the at least the portion of the address mapping table and the logical address and to output a first logical page address in accordance with the at least the portion of the address mapping table and the logical address; and outputting, via the second circuitry, a set of indicators of a physical memory location of the one or more memory devices in accordance with the first logical page address and the one or more parameters.

Aspect 10: The method, apparatus, or non-transitory computer-readable medium of aspect 9, where the set of indicators includes an indicator of a physical page address, an indicator of a memory device of the one or more memory devices, an indicator of a plane of the one or more memory planes, an indicator of a page type of the plurality of page types associated with the physical memory location, and an indicator of a page for the access operation.

Aspect 11: The method, apparatus, or non-transitory computer-readable medium of aspect 10, where the initialization information includes a plurality of page type change point tables, each of the plurality of page type change point tables being associated with a respective page type change point and a respective size of a respective page mapping table.

Aspect 12: The method, apparatus, or non-transitory computer-readable medium of aspect 11, further including operations, features, circuitry, logic, means, or instructions, or any combination thereof for determining, via the second circuitry, a page offset in accordance with the first logical page address, a page type change point of the respective page type change points, and a size of a page mapping table of the respective page mapping tables and inputting, via the second circuitry, the page offset into the page mapping table to determine the memory device and the plane, where outputting the set of indicators of the physical memory location is in response to the page offset being input into the page mapping table.

Aspect 13: The method, apparatus, or non-transitory computer-readable medium of aspect 12, where and the method, apparatuses, and non-transitory computer-readable medium includes operations, features, circuitry, logic, means, or instructions, or any combination thereof for determining, via the second circuitry, the page type change point from the virtual block table in accordance with a virtual block associated with the first logical page address.

Aspect 14: The method, apparatus, or non-transitory computer-readable medium of any of aspects 11 through 13, where each of the plurality of page type change point tables is associated with a respective page type.

Aspect 15: The method, apparatus, or non-transitory computer-readable medium of aspect 14, where each respective page type corresponds to one of a single-level cell type, a multi-level cell type, a triple-level cell type, or a quad-level cell type.

Aspect 16: The method, apparatus, or non-transitory computer-readable medium of any of aspects 14 through 15, where each respective cell type corresponds to one of a lower page, an upper page, or an extra page.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field- effect transistor (FET) and comprise a three terminal device including a source, drain, and gate. The terminals may be connected to other electronic elements through conductive materials, e.g., metals. The source and drain may be conductive and may comprise a heavily- doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open- ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices each configured according to one or more regions of one or more of a plurality of page types;
a controller coupled with the one or more memory devices and configured to identify a logical address associated with an access operation for the memory system and to load at least a portion of an address mapping table, the address mapping table correlating logical addresses to logical page addresses of a logical page address space;
first circuitry configured to obtain the at least the portion of the address mapping table and the logical address, and to output a first logical page address in accordance with the at least the portion of the address mapping table and the logical address; and
second circuitry configured to:
obtain the first logical page address, a quantity of the one or more memory devices, and one or more page type change point tables associated with the one or more regions of the one or more of the plurality of page types; and
output a set of indicators of a physical memory location of the one or more memory devices, wherein the set of indicators comprises an indicator of a physical page address, an indicator of a memory device of the one or more memory devices, an indicator of a page type of the plurality of page types associated with the physical memory location, and an indicator of a page for the access operation.

2. The memory system of claim 1, wherein the second circuitry is further configured to:
determine a page offset in accordance with the first logical page address, a page type change point, and a size of a page mapping table; and
input the page offset into the page mapping table to determine the memory device, wherein outputting the indicator of the physical page address is in accordance with the page offset being input into the page mapping table.

3. The memory system of claim 2, wherein the second circuitry is further configured to determine the page type change point from a virtual block table in accordance with a virtual block associated with the first logical page address, wherein the page type change point is associated with a page type change point table of the one or more page type change point tables.

4. The memory system of claim 3, wherein the second circuitry is further configured to determine the size of the page mapping table in accordance with a page type change point table associated with the page type change point.

5. The memory system of claim 1, wherein each of the one or more memory devices comprises one or more memory planes, and wherein the second circuitry is configured to output the set of indicators of the physical memory location of the one or more memory devices in accordance with a quantity of the one or more memory planes, the set of indicators comprising an indicator of a plane of the one or more memory planes.

6. The memory system of claim 1, wherein the physical page address further comprises an indication of cell type.

7. The memory system of claim 6, wherein the cell type corresponds to a lower page, an upper page, or an extra page.

8. The memory system of claim 1, wherein the page type corresponds to a single-level cell type, a multi-level cell type, a triple-level cell type, or a quad-level cell type.

9. A memory system, comprising:
a controller coupled with one or more memory devices, each of the one or more memory devices having one or more memory planes and configured according to one or more regions of one or more of a plurality of page types; and
first circuitry and second circuitry coupled with the controller,
wherein the controller is configured to:
obtain initialization information in response to detection of a power on condition for the memory system, wherein the initialization information comprises one or more parameters for a page mapping table;
output the one or more parameters to the second circuitry; and
identify a logical address associated with an access operation for the memory system and to load at least a portion of an address mapping table, the address mapping table correlating logical addresses to logical page addresses of a logical page address space,
wherein the first circuitry is configured to:
obtain the at least the portion of the address mapping table and the logical address and to output a first logical page address in accordance with the at least the portion of the address mapping table and the logical address, and
wherein the second circuitry is configured to:
output a set of indicators of a physical memory location of the one or more memory devices in accordance with the first logical page address and the one or more parameters.

10. The memory system of claim 9, wherein the set of indicators comprises an indicator of a physical page address, an indicator of a memory device of the one or more memory devices, an indicator of a plane of the one or more memory planes, an indicator of a page type of the plurality of page types associated with the physical memory location, and an indicator of a page for the access operation.

11. The memory system of claim 10, wherein the initialization information comprises a plurality of page type change point tables, each of the plurality of page type change point tables being associated with a respective page type change point and a respective size of a respective page mapping table.

12. The memory system of claim 11, wherein the second circuitry is further configured to:
determine a page offset in accordance with the first logical page address, a page type change point of the respective page type change points, and a size of a page mapping table of the respective page mapping tables; and
input the page offset into the page mapping table to determine the memory device and the plane, wherein outputting the set of indicators of the physical memory location is in response to the page offset being input into the page mapping table.

13. The memory system of claim 12, wherein the initialization information comprises a virtual block table, and wherein the second circuitry is further configured to determine the page type change point from the virtual block table in accordance with a virtual block associated with the first logical page address.

14. The memory system of claim 11, wherein each of the plurality of page type change point tables is associated with a respective page type.

15. The memory system of claim 14, wherein each respective page type corresponds to one of a single-level cell type, a multi-level cell type, a triple-level cell type, or a quad-level cell type.

16. The memory system of claim 14, wherein each respective cell type corresponds to one of a lower page, an upper page, or an extra page.

17. A method by a memory system, comprising:
identifying, via one or more controllers coupled with one or more memory devices, a logical address associated with an access operation for the memory system and to load at least a portion of an address mapping table, the address mapping table correlating logical addresses to logical page addresses of a logical page address space, wherein the one or more memory devices are each configured according to one or more regions of one or more of a plurality of page types;
obtaining, via first circuitry, the at least the portion of the address mapping table and the logical address;
outputting, via the first circuitry, a first logical page address in accordance with the at least the portion of the address mapping table and the logical address;
obtaining, via second circuitry, the first logical page address, a quantity of the one or more memory devices, and one or more page type change point tables associated with the one or more regions of the one or more of the plurality of page types; and
outputting, via the second circuitry, a set of indicators of a physical memory location of the one or more memory devices, wherein the set of indicators comprises an indicator of a physical page address, an indicator of a memory device of the one or more memory devices, an indicator of a page type of the plurality of page types associated with the physical memory location, and an indicator of a page for the access operation.

18. The method of claim 17, further comprising:
determinizing, via the second circuitry, a page offset in accordance with the first logical page address, a page type change point, and a size of a page mapping table; and
inputting, via the second circuitry, the page offset into the page mapping table to determine the memory device, wherein outputting the indicator of the physical page address is in response to the page offset being input into the page mapping table.

19. The method of claim 18, further comprising:
determining, via the second circuitry, the page type change point from a virtual block table in accordance with a virtual block associated with the first logical page address, wherein the page type change point is associated with a page type change point table of the one or more page type change point tables.

20. The method of claim 19, further comprising:
determining, via the second circuitry, the size of the page mapping table in accordance with a page type change point table associated with the page type change point.

21. The method of claim 17, wherein each of the one or more memory devices comprises one or more memory planes, the method further comprising:
outputting, via the second circuitry, the set of indicators of the physical memory location of the one or more memory devices in accordance with a quantity of the one or more memory planes, the set of indicators comprising an indicator of a plane of the one or more memory planes.

22. The method of claim 17, wherein the physical page address further comprises an indication of cell type.
